(19) United States
(12) Patent Application Publication
(10) Pub. No.: US 2006/0238096 A1
(43) Pub. Date: Oct. 26, 2006

(54) Carbon nanotube structure and method of manufacturing the same, field emission device using the carbon nanotube structure and method of manufacturing the field emission device

(76) Inventors: In-Taek Han, Seoul (KR); Ha-Jin Kim, Suwon-si (KR)

Correspondence Address: Robert E. Bushnell, Suite 300, 1522 K Street, N.W., Washington, DC, 20005-1202, US

(21) Appl. No.: 11/346,216

(22) Filed: Feb. 3, 2006

(30) Foreign Application Priority Data
Feb. 19, 2005 (KR) 10-2005-0013901

(51) Int. Cl. H01J 1/00; H01J 63/04

(52) U.S. Cl. 313/311; 977/842; 313/495; 313/310; 313/336; 313/351

(57) ABSTRACT

In a carbon nanotube (CNT) structure and a method of manufacturing the CNT structure, and in a field emission display (FED) device using the CNT structure and a method of manufacturing the FED device, the CNT structure includes a substrate, a plurality of buffer particles having a predetermined size coated on the substrate, a plurality of catalyst layers formed on surfaces of the buffer particles by annealing a catalyst material deposited on the substrate to a predetermined thickness so as to cover the buffer particles, and a plurality of CNTs grown from the catalyst layers.

### CLAIMS OF PRIORITY

This application makes reference to, incorporates the same herein, and claims all benefits accruing under 35 U.S.C. §119 from an application for CARBON NANOTUBE STRUCTURE AND FABRICATING METHOD THEREOF, AND FIELD EMISSION DEVICE USING THE CARBON NANOTUBE STRUCTURE AND FABRICATING METHOD THEREOF earlier filed in the Korean Intellectual Property Office on Feb. 19, 2005 and there duly assigned Serial No. 10-2005-0013901.

### BACKGROUND OF THE INVENTION

1. Technical Field

The present invention relates to a carbon nanotube structure and a method of manufacturing the same, a field emission display device using the carbon nanotube structure, and a method of manufacturing the field emission device.

2. Related Art

Due to their unique structure and electrical characteristics, carbon nanotubes (CNTs) are used in many devices, such as field emission display (FED) devices, back light devices for liquid crystal display devices, nano-electronic devices, actuators, and batteries.

An FED device is a display device which generates light by the collision of electrons, emitted from an emitter formed on a cathode electrode, with a fluorescent layer formed on an anode electrode. A CNT emitter having a superior electron emission characteristic is mainly used as the emitter of the FED device. The FED device can be manufactured in a simple process and has advantages of low cost, low driving voltage, and high chemical and mechanical stability.

A conventional method of forming CNTs includes a screen printing method which uses a paste and a chemical vapor deposition (CVD) method. The CVD method includes a plasma enhanced chemical vapor deposition (PECVD) and a thermal chemical vapor deposition (thermal CVD). The CVD method enables the manufacture of a high resolution display device and is a simple manufacturing process since the CNTs are directly grown on a substrate. Also, the CVD method provides high purity and well aligned CNTs without additional surface treatment.

However, when CNTs are grown by the CVD method, high density CNTs can be obtained. When the density of the CNTs is too high, not only do the CNTs shield an electric field, but they also increase the driving voltage. Conversely, when the density of the CNTs is too low, the lifetime of the FED device is reduced since a high current flows through each CNT. Therefore, the optimization of the density of CNTs is needed to reduce driving voltage and increase the lifetime of the FED device.

A method of growing CNTs has been disclosed in U.S. Pat. No. 6,764,874. The latter patent discloses a method of growing CNTs from catalyst nano-particles by the CVD method after forming particles composed of Al₂O₃ and the catalyst nano-particles by annealing a substrate on which an Al supporting layer and a Ni catalyst film are deposited to a predetermined thickness. In the latter case, the density of the CNTs is controlled by the thickness of the Al supporting layer and the Ni catalyst film. That is, when the thickness of the Al supporting layer increases, the density of the CNTs increases, and as the thickness of the Ni catalyst film increases, the density of the CNTs decreases. However, this method has a drawback in that the catalyst characteristics of the Ni catalyst film are reduced due to oxidation of Ni since this method accompanies an annealing process under an air atmosphere. Therefore, an additional reduction process for preventing the reduction of the catalyst characteristics of the Ni catalyst film is required.

### SUMMARY OF THE INVENTION

The present invention relates to a carbon nanotube (CNT) structure having an optimum density and a method of manufacturing the CNT structure, a field emission display (FED) device using the CNT structure, and a method of manufacturing the FED device using the CNT structure.

The present invention provides a CNT structure which comprises: a substrate; a plurality of buffer particles having a predetermined size coated on the substrate; a plurality of catalyst layers formed on surfaces of the buffer particles by annealing a catalyst material deposited on the substrate to a predetermined thickness so as to cover the buffer particles; and a plurality of CNTs grown from the catalyst layers.

The buffer particles preferably have a size more than five times greater than the thickness of the catalyst material. Moreover, the buffer particles have a size in a range of 1-100 nm, and preferably 5-25 nm.

The buffer particles can be formed of an oxide of at least one of Si, Al, Ti, TiN, Cr, Ni, and Cu, and the catalyst material can be formed of at least a material selected from Ni, Fe, Co, Pt, Mo, W, Y, and Pd.

According to an aspect of the present invention, a method of manufacturing a CNT structure comprises: coating a plurality of buffer particles having a predetermined size on a substrate; depositing a catalyst material to a predetermined thickness so as to cover surfaces of the buffer particles on the substrate; and growing CNTs from catalyst layers after forming a plurality of catalyst layers on surfaces of the buffer particles through annealing.

The forming of the catalyst layers and the growing of the CNTs can be performed by a CVD method.

According to another aspect of the present invention, an FED device comprises: a substrate; a cathode electrode formed on the substrate; an insulating layer which is formed on the substrate so as to cover the cathode electrode, and which has an emitter hole that exposes a portion of the cathode electrode; a gate electrode which is formed on the insulating layer; and a CNT emitter formed in the emitter hole, and including a plurality of buffer particles having a predetermined size coated on the cathode electrode, a plurality of catalyst layers formed on surfaces of the buffer particles by annealing a catalyst material deposited on the cathode electrode to a predetermined thickness so as to cover the buffer particles, and a plurality of CNTs grown from the catalyst layers.

According to a further aspect of the present invention, a method of manufacturing an FED device comprises: forming an emitter hole which exposes a portion of a cathode electrode in an insulating layer after sequentially forming the cathode electrode, the insulating layer and a gate electrode on a substrate; coating a plurality of buffer particles having a predetermined size on the cathode electrode exposed through the emitter hole; depositing a catalyst material on the cathode electrode to a predetermined thickness so as to cover surfaces of the buffer particles; and growing CNTs from catalyst layers after forming a plurality of catalyst layers on the surfaces of the buffer particles through annealing.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an SEM image of high density carbon nanotubes (CNTs) grown by a chemical vapor deposition (CVD) method;

FIG. 2 is a cross-sectional view illustrating a CNT structure according to an embodiment of the present invention;

FIG. 3A is a cross-sectional view illustrating high density CNTs grown by using small size buffer particles in the CNT structure according to the present invention;

FIG. 3B is a cross-sectional view illustrating low density CNTs grown by using large size buffer particles in the CNT structure according to the present invention;

FIGS. 4A thru 4D are cross-sectional views illustrating a method of manufacturing a CNT structure according to an embodiment of the present invention;

FIG. 5 is a cross-sectional view illustrating a field emission display (FED) device according to the present invention;

FIGS. 6A thru 6D are cross-sectional views illustrating a method of manufacturing an FED device according to another embodiment of the present invention; and

FIGS. 7A and 7B are SEM images of the states of light emitting images of an FED device when 25 nm and 50 nm, respectively, of buffer particles are used.

### DETAILED DESCRIPTION OF THE INVENTION

The present invention will now be described more fully with reference to the accompanying drawings in which embodiments of the present invention are shown. In the drawings, the thicknesses of layers and regions are exaggerated for clarity. Like reference numerals refer to the like elements throughout the drawings.

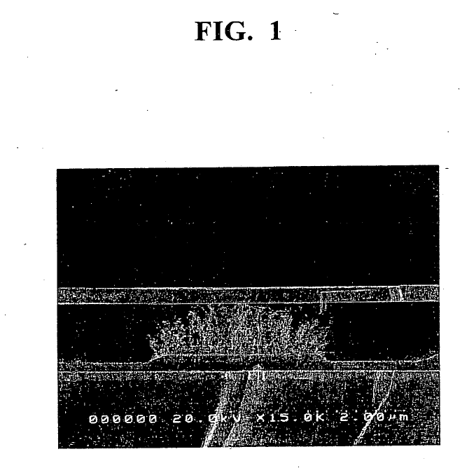

FIG. 1 is am SEM image of high density carbon nanotubes (CNTs) grown by a chemical vapor deposition (CVD) method. As depicted in FIG. 1, when CNTs are grown by a CVD method, high density CNTs can be obtained. However, when the density of the CNTs is too high, not only do the CNTs shield an electric field, but they also increase the driving voltage. Conversely, when the density of the CNTs is too low, the lifetime of the FED device is reduced since a high current flows through each CNT. Therefore, the optimization of the density of CNTs is needed to reduce driving voltage and increase the lifetime of the FED device.

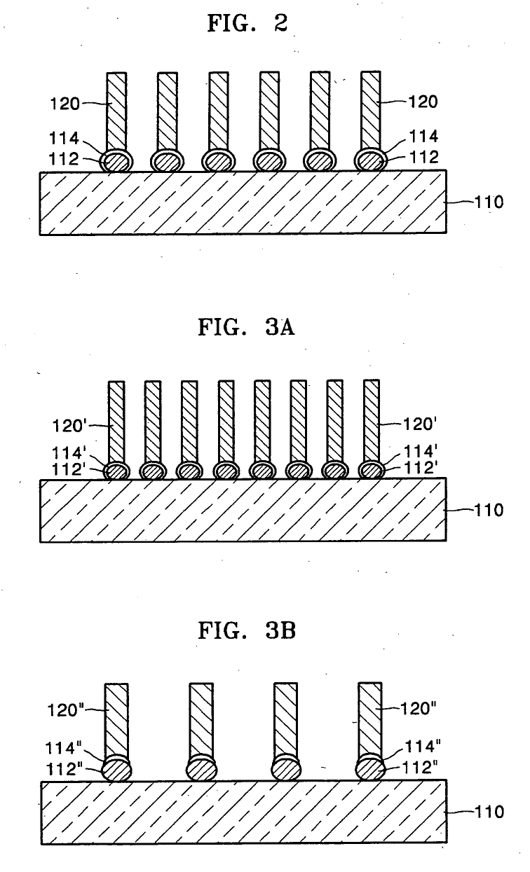

FIG. 2 is a cross-sectional view illustrating a carbon nanotube (CNT) structure according to an embodiment of the present invention; FIG. 3A is a cross-sectional view illustrating high density CNTs grown by using small size buffer particles in the CNT structure according to the present invention; and FIG. 3B is a cross-sectional view illustrating low density CNTs grown by using large size buffer particles in the CNT structure according to the present invention.

Referring to FIG. 2, the CNT structure includes a substrate 110, a plurality of buffer particles 112 coated on the substrate 110, a plurality of catalyst layers 114 formed on surfaces of the buffer particles 112, and a plurality of CNTs 120 grown from the catalyst layers 114.

The buffer particles 112 can be formed in a spherical shape, an oval shape, a needle shape, or various protrusion shapes. In addition, the buffer particles 112 can be formed of a conductor or a nonconductor. However, the buffer particles 112 are preferably formed of a material that does not deform at a temperature at which the CNTs 120 are synthesized. More specifically, the buffer particles 112 are formed of an oxide of at least one of Si, Al, Ti, TiN, Cr, Ni, and Cu.

The catalyst layers 114 are formed on surfaces of the buffer particles 112 by annealing 1 a catalyst material deposited to a predetermined thickness so as to cover the buffer particles 112 on the substrate 110 using a chemical vapor deposition (CVD) method. The catalyst layers 114 are preferably formed of at least a material selected from Ni, Fe, Co, Pt, Mo, W, Y, and Pd.

The CNTs 120 are grown from the catalyst layers 114 by a CVD method. The CVD method can be a thermal CVD or a plasma enhanced chemical vapor deposition (PECVD) method.

The CNTs 120 grown from the catalyst layers 114 must have an appropriate density to increase field emission characteristics. FIGS. 3A and 3B show CNTs 120′ and 120″, respectively, grown from catalyst layers 114′ and 114″, respectively, when buffer particles 112′ and 112″, respectively, having a smaller size and a larger size, respectively, than a required size are used. In this respect, the catalyst layers 114′ and 114″ are grown using the same amount of a catalyst material on surfaces of the small buffer particles 112′ and the larger buffer particles 112″, respectively. Referring to FIG. 3A, when small buffer particles 112′ are used, the density of the CNTs 120′ grown from the catalyst layers 114′ increases. When the density of the CNTs 120′ is too high, each of the CNTs 120′ not only shields the field emission display (FED) device but also increases the driving voltage. Referring to FIG. 3B, when large buffer particles 112″ are used, the density of the CNTs 120″ grown from the catalyst layers 114″ decreases. When the density of the CNTs 120″ is too low, there is a problem of a high current flow in each of the CNTs 120″. Therefore, the CNTs 120 must be grown so as to have an optimum density so as to increase the field emission characteristics of the CNTs 120.

In the present invention, if the size of the buffer particles 112 and the thickness of the catalyst material for forming catalyst layers 114 are controlled, the density of the CNTs 120 can be optimized. For this purpose, in the present embodiment, buffer particles 112 having a thickness sufficiently greater than the thickness of the catalyst material are used. More specifically, the buffer particles 112 preferably have a size more than five times greater than the thickness of the catalyst material. In this regard, the buffer particles 112 have a size in a range of approximately 1-100 nm, and preferably 5-25 nm.

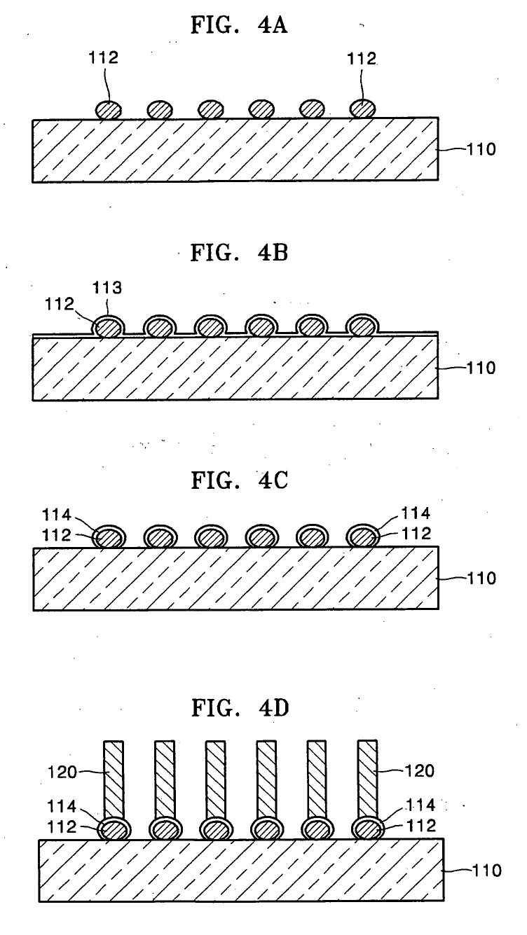

A method of manufacturing the CNT structure will now be described with reference to FIGS. 4A thru 4D, which are cross-sectional views illustrating a method of manufacturing a CNT structure according to an embodiment of the present invention.

Referring to FIG. 4A, a plurality of buffer particles 112 having a predetermined size are coated on a substrate 110. The method of coating the buffer particles 112 can be a spray method, a spin coating method, or a dipping method. The buffer particles 112 can be formed in the shape of a sphere, an oval, or a needle, or in various protrusion shapes. In addition, the buffer particles 112 can be formed of a conductor or a nonconductor. However, the buffer particles 112 are preferably formed of a material that does not deform at a temperature at which the CNTs 120 are synthesized. More specifically, the buffer particles 112 are formed of an oxide of at least one of Si, Al, Ti, TiN, Cr, Ni, and Cu. The buffer particles 112 preferably have a size more than five times greater than the thickness of the catalyst material 113 (see FIG. 4B), which will be described later. The buffer particles 112 have a size in a range of approximately 1-100 nm, and preferably 5-25 nm.

Referring to FIG.4B, a catalyst material 113 is deposited to a predetermined thickness on the substrate 110 so as to cover the buffer particles 112. The deposition of the catalyst material 13 can be performed by sputtering or electron beam evaporation. The catalyst material 113 can be at least a material selected from Ni, Fe, Co, Pt, Mo, W, Y, and Pd.

Referring to FIG. 4C, catalyst layers 114 for forming CNTs 120 are formed on surfaces of the buffer particles 112. More specifically, when the catalyst material 113 deposited on surfaces of the substrate 110 and the buffer particles 112 is annealed, the catalyst material 113 on the substrate 110 migrates toward the surfaces of the buffer particles 112 due to the surface energy difference between the substrate 110 and the buffer particles 112. Accordingly, the catalyst layers 114 are formed on the surfaces of the buffer particles 112. In this regard, the annealing of the catalyst material 113 can be performed at the same time as performing a CVD method for growing the CNTs 120.

Referring to FIG. 4D, CNTs 120 are grown from the catalyst layers 114 formed on the surfaces of the buffer particles 112 by a CVD method. The CVD method can be a thermal CVD method or a PECVD method.

The CNTs 120 grown by the thermal CVD method have superior growth uniformity since the temperature on the entire specimen is uniform, and such CNTs 120 also have a low turn on voltage since they have a smaller diameter than CNTs grown by the PECVD method. On the other hand, the PECVD method has the advantages of being able to grow the CNTs 120 in a vertical direction relative to the substrate 110, and of being able to synthesize the CNTs 120 at a lower temperature than that of the thermal CVD method.

An FED device using the CNT structure will now be described with reference to FIG.5, which is a cross-sectional view illustrating an FED device according to the present invention.

Referring to FIG. 5, an FED device 240 according to the present invention includes a substrate 210, a cathode electrode 230, an insulating layer 232, and a gate electrode 234 sequentially stacked on the substrate 210, and a CNT emitter 250.

The substrate 210 can be formed of glass. The cathode electrode 230, patterned in a predetermined shape, is deposited on a surface of the substrate 210. The cathode electrode 230 can be formed of a transparent conductive material, such as indium tin oxide (ITO). The insulating layer 232 which covers the cathode electrode 230 is formed on the substrate 210. An emitter hole 240 which exposes a portion of the cathode electrode 230 is formed in the insulating layer 232. The gate electrode 234 is deposited on an upper surface of the insulating layer 232. The gate electrode 234 can be formed of conductive metal, such as chromium (Cr).

The CNT emitter 250 for emitting electrons as a result of a voltage applied between the cathode electrode 230 and the gate electrode 234 is disposed within the emitter hole 240. The CNT emitter 250 includes a plurality of buffer particles 212 coated on the cathode electrode 230, a plurality of catalyst layers 214 formed on surfaces of the buffer particles 212, and a plurality of CNTs 220 grown from the catalyst layers 214.

The buffer particles 212 can be formed in a spherical shape, an oval shape, a needle shape, or various protrusion shapes. Also, as described above, the buffer particles 212 can be formed of an oxide of at least one of Si, Al, Ti, TiN, Cr, Ni, and Cu. To increase the FED characteristics of the CNTs 220 by optimizing the density of the CNTs 220, the buffer particles 212 are preferably formed in a size more than five times greater than a thickness of a catalyst material for forming the catalyst layers 214. In this respect, the buffer particles 212 have a size in a range of approximately 1-100 nm, and preferably 5-25 nm.

The catalyst layers 214 can be formed on surfaces of the buffer particles 212 by annealing a catalyst material deposited on the cathode electrode 230 to a predetermined thickness so as to cover the buffer particles 212 using a CVD method. As described above, the catalyst layers 214 can be formed of at least a material selected from Ni, Fe, Co, Pt, Mo, W, Y, and Pd.

The CNTs 220 are grown from the catalyst layers 214 by a CVD method. The CVD method can be a thermal CVD method or a PECVD method.

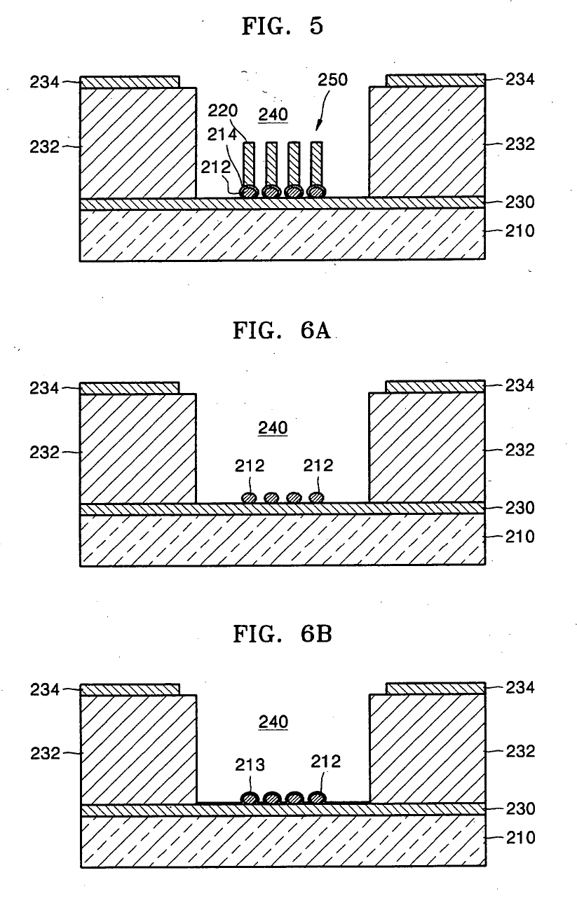

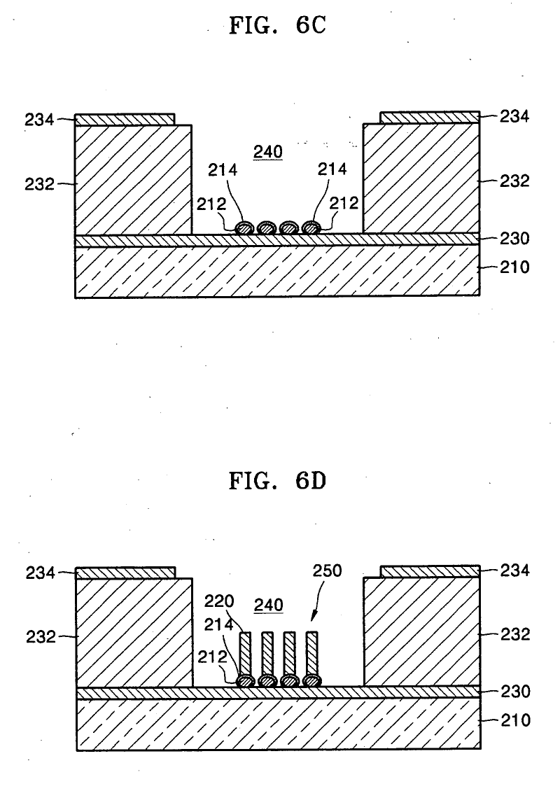

A method of manufacturing the FED device will now be described with reference to FIGS. 6A thru 6D, which are cross-sectional views illustrating a method of manufacturing a FED device according to another embodiment of the present invention.

Referring to FIG. 6A, after sequentially forming a cathode electrode 230, an insulating layer 232, and a gate electrode 234 on a substrate 210, an emitter hole 240 which exposes a portion of the cathode electrode 230 is formed in the insulating layer 232. The substrate 210 can be formed of glass. The cathode electrode 230 can be formed of a transparent conductive material, such as ITO, and the gate electrode 234 can be formed of a conductive metal, such as Cr.

More specifically, after depositing a transparent conductive material, such as ITO, to a predetermined thickness, the cathode electrode 230 is formed by patterning the transparent conductive material to a predetermined shape, such as a stripe shape. Next, an insulating layer 232 is formed to a predetermined thickness on substrate 210 so as to cover the cathode electrode 230. After depositing a conductive metal, such as Cr, to a predetermined thickness on the insulating layer 232 by sputtering, a gate electrode 234 is formed by patterning the conductive metal to a predetermined shape. An emitter hole 240 is formed by etching the insulating layer 232 exposed through the gate electrode 234 until the cathode electrode 230 is exposed.

A plurality of buffer particles 212 having a predetermined size is coated on the cathode electrode 230 exposed through the emitter hole 240. In this regard, the coating of the buffer particles 212 can be performed by a spray method, a spin coating method, or a dipping method. The buffer particles 212 can be formed of oxide of at least one of Si, Al, Ti, TiN, Cr, Ni, and Cu. The buffer particles 212 preferably have a size more than five times greater than a thickness of a catalyst material 213 (see FIG. 6B), which will be described later. The buffer particles 212 have a size in a range of approximately 1-100 nm, and preferably 5-25 nm.

Referring to FIG. 6B, a catalyst material 213 is deposited on the cathode electrode 230 to a predetermined thickness so as to cover the buffer particles 212. In this respect, the deposition of the catalyst material 213 can be performed by a sputtering method or an electron beam deposition method. The catalyst material 213 can be formed of at least a material selected from Ni, Fe, Co, Pt, Mo, W, Y, and Pd.

Referring to FIG. 6C, a plurality of catalyst layers 214 for growing CNTs 220 (see FIG. 6D) is formed on surfaces of the buffer particles 212. More specifically, when the catalyst material 213 deposited on surfaces of the cathode electrode 230 and the buffer particles 212 are annealed, the catalyst material 213 on the substrate 210 migrates toward the surfaces of the buffer particles 212 due to the surface energy difference between the cathode electrode 230 and the buffer particles 212. Accordingly, catalyst layers 214 are formed on the surfaces of the buffer particles 212. In this respect, the annealing of the catalyst material 213 can be performed at the same time as performing a CVD method for growing the CNTs 120.

Referring to FIG. 6D, the formation of CNT emitters 250 in the emitter hole 240 is completed when CNTs 120 are grown from the catalyst layers 214 formed on the surfaces of the buffer particles 212 by a CVD method. The CVD method can be a thermal CVD method or a PECVD method.

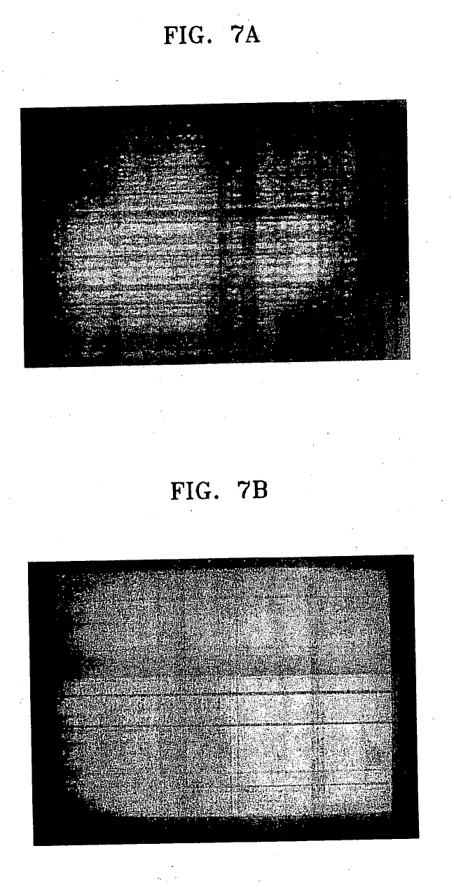

FIGS. 7A and 7B are SEM images of light emitting images of an FED device when 25 nm and 50 nm, respectively, of buffer particles are used. In this case, Al₂O₃ particles are used as the buffer particles and an invar (an alloy of Fe, Ni, and Co) having a 2 nm thickness is used as the catalyst material. Referring to FIGS. 7A and 7B, the light emitting image of the FED device which uses the buffer particles of 50 nm size is improved more than that of the FED device which uses the buffer particles of 25 nm size. This is because the amount of emitting current in the FED device which uses the buffer particles of 50 nm size is significantly greater than the amount of emitting current in the FED device which uses the buffer particles of 25 nm size.

As described above, the present invention has the following advantages.

First, the density and diameter of CNTs can be controlled by controlling the size of buffer particles and the thickness of a catalyst material. Therefore, an optimized density of CNTs can be obtained, thus significantly increasing the field emission characteristics of the FED device.

Second, the manufacturing process can be simplified by directly coating the buffer particles having a predetermined size, and the problem of oxidizing the catalyst layers can be prevented since the process is not performed under an oxidation atmosphere.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A carbon nanotube (CNT) structure, comprising:
a substrate;
a plurality of buffer particles having a predetermined size coated on the substrate;
a plurality of catalyst layers formed on surfaces of the buffer particles by annealing a catalyst material deposited on the substrate to a predetermined thickness so as to cover the buffer particles; and
a plurality of CNTs grown from the catalyst layers.

2. The CNT structure of claim 1, wherein the predetermined size of the buffer particles is more than five times greater than the predetermined thickness of the catalyst material.

3. The CNT structure of claim 2, wherein the predetermined size of the buffer particles is in a range of 1-100 nm.

4. The CNT structure of claim 3, wherein the predetermined size of the buffer particles is in a range of 5-25 nm.

5. The CNT structure of claim 1, wherein the buffer particles are formed of an oxide of at least one selected from the group consisting of Si, Al, Ti, TiN, Cr, Ni, and Cu.

6. The CNT structure of claim 1, wherein the catalyst layers are formed of at least a material selected from the group consisting of Ni, Fe, Co, Pt, Mo, W, Y, and Pd.

7. A method of manufacturing a carbon nanotube (CNT) structure, comprising the steps of:
coating a plurality of buffer particles having a predetermined size on a substrate;
depositing a catalyst material to a predetermined thickness so as to cover surfaces of the buffer particles on the substrate;
forming a plurality of catalyst layers on the surfaces of the buffer particles through an annealing; and
growing CNTs from the catalyst layers.

8. The method of claim 7, wherein the step of forming the plurality of catalyst layers and the step of growing the CNTs are performed by a chemical vapor deposition (CVD) method.

9. The method of claim 8, wherein the CVD method is one of a thermal CVD method and a plasma enhanced chemical vapor deposition (PECVD) method.

10. The method of claim 7, wherein the buffer particles are coated by one of a spray method, a spin coating, and a dipping method.

11. The method of claim 7, wherein the predetermined size of the buffer particles is more than five times greater than the predetermined thickness of the catalyst material.

12. The method of claim 7, wherein the predetermined size of buffer particles is in a range of 1-100 nm.

13. The method of claim 12, wherein the predetermined size of buffer particles is in a range of 5-25 nm.

14. The method of claim 7, wherein he buffer particles are formed of an oxide of at least one selected from the group consisting of Si, Al, Ti, TiN, Cr, Ni, and Cu.

15. The method of claim 7, wherein the catalyst material is deposited by one of a sputtering method and an electron beam evaporation method.

16. The method of claim 7, wherein the catalyst material is formed of at least a material selected from the group consisting of Ni, Fe, Co, Pt, Mo, W, Y, and Pd.

17. The method of claim 7, wherein the catalyst layers are formed by migration of the catalyst material on the substrate toward surfaces of the buffer particles due to a surface energy difference between the substrate and the buffer particles.

18. A CNT structure manufactured by the method of claim 7.

19. A field emission display (FED) device, comprising:
a substrate;
a cathode electrode formed on the substrate;
an insulating layer formed on the substrate so as to cover the cathode electrode and having an emitter hole which exposes a portion of the cathode electrode;
a gate electrode formed on the insulating layer; and
a carbon nanotube (CNT) emitter formed in the emitter hole and including a plurality of buffer particles having a predetermined size coated on the cathode electrode, a plurality of catalyst layers formed on surfaces of the buffer particles by annealing a catalyst material deposited on the cathode electrode to a predetermined thickness so as to cover the buffer particles, and a plurality of CNTs grown from the catalyst layers.

20. The FED device of claim 19, wherein the predetermined size of the buffer particles is more than five times greater than the predetermined thickness of the catalyst material.

21. The FED device of claim 20, wherein the predetermined size of the buffer particles is in a range of 1-100 nm.

22. The FED device of claim 21, wherein the predetermined size of the buffer particles is in a range of 5-25 nm.

23. The FED device of claim 19, wherein the buffer particles are formed of an oxide of at least one selected from the group consisting of Si, Al, Ti, TiN, Cr, Ni, and Cu.

24. The FED device of claim 19, wherein the catalyst layers are formed of at least a material selected from the group consisting of Ni, Fe, Co, Pt, Mo, W, Y, and Pd.

25. A method of manufacturing a field emission display (FED) device, comprising the steps of:
sequentially forming a cathode electrode, an insulating layer and a gate electrode on a substrate;
forming an emitter hole which exposes a portion of the cathode electrode in the insulating layer;
coating a plurality of buffer particles having a predetermined size on the cathode electrode exposed through the emitter hole;
depositing a catalyst material on the cathode electrode to a predetermined thickness so as to cover surfaces of the buffer particles;
forming a plurality of catalyst layers on the surfaces of the buffer particles through an annealing; and
growing carbon nanotubes (CNTs) from the catalyst layers.

26. The method of claim 25, wherein the step of forming the catalyst layers and the step of growing the CNTs are performed by a chemical vapor deposition (CVD) method.

27. The method of claim 25, wherein the buffer particles are coated by one of a spray method, a spin coating, and a dipping method.

28. The method of claim 25, wherein the predetermined size of the buffer particles is more than five times greater than the predetermined thickness of the catalyst material.

29. The method of claim 28, wherein the predetermined size of the buffer particles is in a range of 1-100 nm.

30. The method of claim 29, wherein the predetermined size of the buffer particles is in a range of 5-25 nm.

31. The method of claim 25, wherein the buffer particles are formed of an oxide of at least one selected from the group consisting of Si, Al, Ti, TiN, Cr, Ni, and Cu.

32. The method of claim 25, wherein the catalyst material is deposited by one of a sputtering method and an electron beam deposition method.

33. The method of claim 25, wherein the catalyst material is formed of at least a material selected from the group consisting of Ni, Fe, Co, Pt, Mo, W, Y, and Pd.

34. The method of claim 25, wherein the catalyst layers are formed by migration of the catalyst material on the substrate toward surfaces of the buffer particles due to a surface energy difference between the substrate and the buffer particles.

35. An FED device manufactured by the method of claim 25.
